(19) United States
(12) Patent Application Publication
(10) Pub. No.: US 2026/0116104 A1
(43) Pub. Date: Apr. 30, 2026

(54) PRINTING DEVICE

(71) Applicant: SEIKO EPSON CORPORATION, Tokyo (JP)

(72) Inventors: Yuki INOUE, SHIOJIRI-SHI (JP); Taku HIRASHIMA, MATSUMOTO-SHI (JP)

(21) Appl. No.: 19/374,183

(22) Filed: Oct. 30, 2025

(30) Foreign Application Priority Data
Oct. 31, 2024 (JP) 2024-191805

(51) Int. Cl. B41J 15/04; B41J 3/407; B41J 11/00

(52) U.S. Cl. CPC B41J 15/046; B41J 3/4075; B41J 11/0095

(57) ABSTRACT

A printing device includes: a conveying roller that extends in a direction intersecting a direction of conveyance along a surface of a print medium and conveys the print medium; a print head that is located downstream of the conveying roller in a conveyance path of the print medium; an amount-of-skew measurement unit that measures an amount of skew occurring in the print medium; a support shaft that extends in a direction intersecting the surface of the print medium and is coupled to the conveying roller; a rotation drive unit that rotates the conveying roller via the support shaft; and a control unit, wherein the control unit performs feedback control for driving the rotation drive unit according to a measurement result from the amount-of-skew measurement unit.

The present application is based on, and claims priority from JP Application Serial Number 2024-191805, filed Oct. 31, 2024, the disclosure of which is hereby incorporated by reference herein in its entirety.

### BACKGROUND

### 1. Technical Field

The present disclosure relates to a printing device.

### 2. Related Art

JP-A-2023-106036 discloses a printing device that appropriately controls the tension of a label sheet and the tension of a backing sheet and appropriately controls the conveying speed of the label sheet.

The printing device disclosed in JP-A-2023-106036 includes a first roller disposed upstream of a separation unit, a second roller disposed downstream of the separation unit, a first motor that drives the first roller, a second motor that drives the second roller, and a control unit, and the control unit includes a first motor control unit that adjusts a first voltage to be applied to the first motor, based on information about a conveying speed and a conveyance acceleration of a label sheet, such that a load torque of the first motor reaches a target torque, and a second motor control unit that performs feedback control on a second voltage to be applied to the second motor, based on information about a conveying speed of a backing sheet, such that the conveying speed of the backing sheet reaches a target conveying speed.

JP-A-2023-106036 is an example of the related art.

In the printing device disclosed in JP-A-2023-106036, the conveying force with which the second roller, which is another roller, feeds the label sheet, is controlled so as not to exceed the holding force with which the first roller, which is the conveying roller for conveying the label sheet, holds the label sheet.

However, in such a printing device, when a positional deviation or a variation in the load of the conveying roller or another roller occurs, the balance between the holding force of the first roller and the conveying force of another roller is lost and a skew may occur in a print medium such as a label sheet.

### SUMMARY

According to an aspect of the present disclosure, a printing device includes: a conveying roller that extends in a direction intersecting a direction of conveyance along a surface of a print medium and conveys the print medium; a print head that is located downstream of the conveying roller in a conveyance path of the print medium; an amount-of-skew measurement unit that measures an amount of skew occurring in the print medium; a support shaft that extends in a direction intersecting the surface of the print medium and is coupled to the conveying roller; a rotation drive unit that rotates the conveying roller via the support shaft; and a control unit, wherein the control unit performs feedback control for driving the rotation drive unit according to a measurement result from the amount-of-skew measurement unit.

### BRIEF DESCRIPTION OF THE DRAWINGS

FIG. 1 is a side view showing main parts of each part of a conveyance path in a printing device.

FIG. 2 is a perspective view of a paper guide unit as viewed from the left.

FIG. 3 is a perspective view of the paper guide unit as viewed from the right.

FIG. 4 is a perspective view of the fixed hold-down member as viewed from the left.

FIG. 5 is a cross-sectional view taken along a plane V in FIG. 4.

FIG. 6 is a side view showing a rotating member and a rotation drive unit.

FIG. 7 is a plan view showing a drive member and the rotation drive unit.

FIG. 8 is a block diagram showing the configuration of the control system of the printing device.

FIG. 9 is a plan view showing a label sheet conveyed by a conveying roller.

FIG. 10 is a flowchart showing an example of control of the printing device.

FIG. 11 is a plan view showing the label sheet conveyed by the conveying roller.

### DESCRIPTION OF EMBODIMENTS

An embodiment of the present disclosure will now be described with reference to the drawings. In the description, the directions of front, rear, left, right, up, and down are the same as the directions in relation to a printing device 1 unless otherwise stated. In the drawings, a reference sign FR indicates a forward direction in relation to the printing device 1, a reference sign UP indicates an upward direction in relation to the printing device 1, and a reference sign LH indicates a leftward direction in relation to the printing device 1.

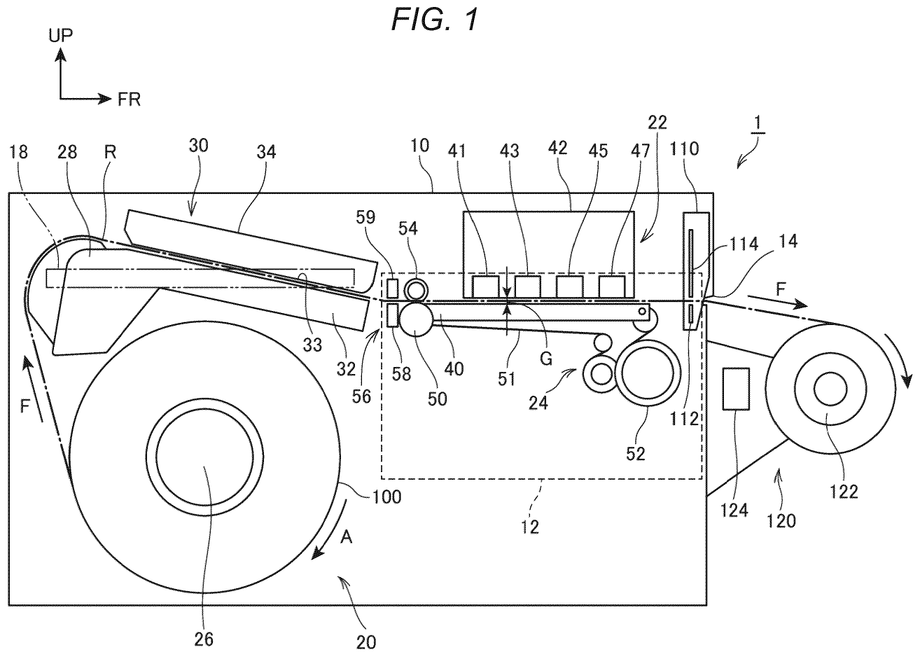

FIG. 1 is a side view showing main parts of each part related to a conveyance path R in the printing device 1.

In FIG. 1, for the convenience of description, the conveyance path R is indicated by a one-dot chain line.

The printing device 1 is a printer that ejects an ink from an inkjet head and thus prints characters and images on a print medium.

A print medium used for printing in the printing device 1 is a cut sheet cut into a predetermined size or a continuous sheet. These sheets are formed of a paper, a synthetic resin, or the like. The sheets may also be a fine paper with a surface treatment performed thereon that is suitable for inkjet printing and that improves ink absorbency and fixability.

The continuous sheet may be a rolled paper stored in the printing device 1 in the state of being wound into a roll, or a fanfold paper supplied in a folded state from outside the printing device 1 to the printing device 1. The rolled paper may be a normal paper or a fine paper that is wound into a roll, or a label sheet that includes a separation sheet on which labels of a regular size with a pressure-sensitive adhesive applied to the back surface are arranged side by side and that is wound into a roll.

In the present embodiment, a label sheet 100 that is wound into a roll, including a backing sheet on which a label 103 of a predetermined size having a pressure-sensitive adhesive applied to the back surface is disposed, the backing sheet having a separation sheet separable from the pressure-sensitive adhesive and formed in a long shape, is used as the print medium. The label sheet 100 has a plurality of labels 103 disposed at equal intervals in the longitudinal direction of a backing sheet 101. The printing device 1 conveys the label sheet 100 and prints a text or an image on the printing surface of the labels 103 on the label sheet 100. The label sheet 100 is an example of a print medium.

The label sheet 100, the backing sheet 101, and the label 103 are illustrated in the drawings described below.

The printing device 1 includes a device case 10 that is a substantially rectangular parallelepiped housing. The device case 10 is formed of a combination of side panels, a front panel, and the like, and forms the outer shell of the printing device 1.

As shown in FIG. 1, a slit-like paper discharge port 14 extending in the left-right direction is formed substantially at the center and slightly to the left, of the front surface of the device case 10. In the printing device 1, the printed label sheet 100 is discharged from the paper discharge port 14.

The printing device 1 includes an accommodation unit 20 that accommodates the label sheet 100, a printing unit 22 that performs printing on the label sheet 100, and a conveying unit 24 that conveys the label sheet 100 from the accommodation unit 20 to the printing unit 22.

In the printing device 1, the accommodation unit 20 is provided on the rear side, and the printing unit 22 is provided on the front side of the accommodation unit 20. The conveying unit 24 is provided below the printing unit 22.

The accommodation unit 20 includes a roll shaft 26 to which the label sheet 100 is attached. The roll shaft 26 is a rod-shaped member provided to be rotatable in the circumferential direction. The label sheet 100 is accommodated in the accommodation unit 20 as the roll shaft 26 is inserted through the center of the roll of the label sheet 100.

For example, a drive device such as a motor may be coupled to the roll shaft 26, and the roll shaft 26 may rotate with the driving of the drive device. In the printing device 1, the label sheet 100 rotates as the roll shaft 26 rotates.

In the printing device 1, a conveyance path R is formed in which one end of the label sheet 100 attached to the roll shaft 26 is pulled out and conveyed to the paper discharge port 14.

In the conveyance path R, a tension lever 28 is attached above the label sheet 100 housed in the accommodation unit 20. The tension lever 28 has a curved surface in the circumferential direction and is formed in a columnar shape extending in the left-right direction. The tension lever 28 applies a tension to the label sheet 100 to prevent a slack. One end of the label sheet 100 is pulled upward, comes into contact with the tension lever 28, is bent by the tension lever 28, and then extends forward.

A paper guide unit 30 is provided to the front of the tension lever 28. The paper guide unit 30 guides the label sheet 100 forward, and suppresses a skew of the label sheet 100 and a deviation in the conveyance of the label sheet 100.

The paper guide unit 30 includes a lower guide member 32 that supports the label sheet 100 from below, and a paper hold-down member 34 located on the upper surface side of the label sheet 100.

In the paper guide unit 30, the label sheet 100 is conveyed in the state of being sandwiched between the lower guide member 32 and the paper hold-down member 34.

In the description below, a direction in which the label sheet 100 is conveyed in an area downstream of the tension lever 28 when a skew does not occur in the conveyance path R is referred to as a direction of conveyance F. The direction of conveyance F is a direction extending linearly along the front-rear direction.

The printing unit 22, which prints on the label sheet 100, is provided to the front of the paper guide unit 30. The printing unit 22 includes a print head 42. The print head 42 in the present embodiment ejects inks of four colors of C (cyan), M (magenta), Y (yellow), and K (black), and thus forms dots on the printing surface of the label 103. The print head 42 has a nozzle unit 41 that ejects the black (K) ink, a nozzle unit 43 that ejects the cyan (C) ink, a nozzle unit 45 that ejects the magenta (M) ink, and a nozzle unit 47 that ejects the yellow (Y) ink.

The print head 42 is not limited to four colors, and may be able to eject inks of four or more colors such as six colors or eight colors.

In the nozzle units 41 to 47, a plurality of nozzles for ejecting the ink are arranged in a row in the width direction of the label sheet 100. The nozzles provided in each of the nozzle units 41 to 47 are arranged along an intersecting direction I intersecting the direction of conveyance F. In the present embodiment, the intersecting direction I is a direction orthogonal to the direction of conveyance F. The intersecting direction I coincides with the width direction of the label sheet 100.

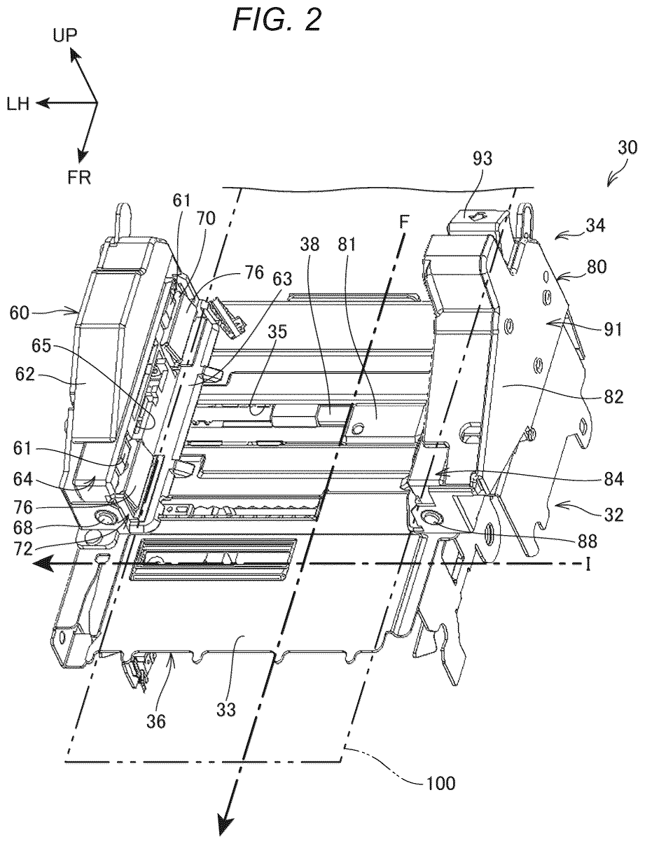

The intersecting direction I is shown in FIGS. 2 to 4, described later.

The print head 42 is an inkjet line head that can eject an ink in the width direction of the label sheet 100 without scanning. Therefore, the nozzle rows in the nozzle units 41 to 47 are formed to have at least the same width as or a wider width than the printable range on the label sheet 100. In the present embodiment, the printable range corresponds to the printing surface of the label 103.

In the present embodiment, a configuration example in which the nozzle units 41, 43, 45, 47 are disposed in this order in the direction of conveyance F of the label sheet 100 is described, but the nozzles of the respective colors may be disposed in any order in the direction of conveyance F.

In the conveying unit 24, a platen 40 has a flat surface disposed along the direction of conveyance F. This flat surface is located below the conveyance path R and faces the print head 42. The nozzle units 41 to 47 and the platen 40 are disposed with a gap G therebetween, which is a platen gap.

The platen 40 supports the label sheet 100 from below. The platen 40 is provided at least over the entire printing range in the printing unit 22. The flat surface of the platen 40 is disposed substantially horizontally when the printing device 1 is in an installed state and in use.

The conveying unit 24 includes a cylindrical conveying roller 50. The conveying roller 50 is disposed such that the longitudinal direction thereof extends along the intersecting direction I, and is provided to be rotatable in the circumferential direction. The conveying roller 50 is disposed to the front of the paper guide unit 30 and at the rear end of the platen 40.

For example, a driven wheel is provided at one end part of the conveying roller 50. A transmission belt 51 is laid on the driven wheel. The transmission belt 51 is laid on a drive shaft provided in a conveyance motor 52. Thus, the conveying roller 50 and the conveyance motor 52 are coupled together via the transmission belt 51.

The conveyance motor 52 is a drive device that drives the conveying roller 50 to rotate. The conveyance motor 52 and the transmission belt 51 are provided below the platen 40.

The conveying unit 24 includes a plurality of paper feed driven rollers 54. The plurality of paper feed driven rollers 54 are rotatably disposed along the longitudinal direction of the conveying roller 50. The paper feed driven rollers 54 are each energized such that the circumferential surface thereof comes into contact with the circumferential surface of the conveying roller 50. Thus, the conveying roller 50 and the paper feed driven roller 54 are disposed to face each other.

Therefore, the conveying roller 50 is disposed on the lower guide member 32 side, and the paper feed driven roller 54 is disposed on the paper hold-down member 34 side.

In the conveying unit 24, when the conveyance motor 52 is driven, the conveying roller 50 is driven to rotate via the transmission belt 51, and the paper feed driven roller 54 follows this and is driven to rotate. Thus, the label sheet 100 loaded between the lower guide member 32 and the paper hold-down member 34 is sandwiched between the conveying roller 50 and the paper feed driven roller 54, and is conveyed to the printing unit 22 as the conveying roller 50 is driven to rotate.

The conveying roller 50 may be disposed on the paper hold-down member 34 side, in other words, on the print head 42 side. Also, for example, the conveying unit 24 may include a conveying belt movable on the upper surface of the platen 40, instead of the conveying roller 50.

In the printing device 1, a label detector 56 is provided downstream of the paper guide unit 30 and upstream of the conveying roller 50 in the conveyance path R. The label detector 56 detects the leading end and the trailing end of the label sheet 100 and the leading end and the trailing end of the label 103.

The label detector 56 is, for example, an optical transmissive sensor including a light emitting unit 58 on the lower surface side of the label sheet 100 and a light receiving unit 59 on the upper surface side of the label sheet 100 in the conveyance path R. The light emitting unit 58 and the light receiving unit 59 are disposed to face each other along the up-down direction with a gap therebetween that allows the label sheet 100 to pass therethrough. That is, the light emitting unit 58 and the light receiving unit 59 are disposed at substantially the same position in the front-rear direction.

The label detector 56 may be disposed downstream of the conveying roller 50 and upstream of the print head 42. For example, the light emitting unit 58 may be disposed on the paper hold-down member 34 side, and the light receiving unit 59 may be disposed on the lower guide member 32 side. Similarly, the light emitting unit 58 may be disposed on the platen 40 side, and the light receiving unit 59 may be disposed on the print head 42 side.

For example, a light emitting element such as a light-emitting diode (LED) is used as the light emitting unit 58.

For example, a light receiving element such as a phototransistor, a photo IC, or a photodiode is used as the light receiving unit 59. When receiving light having a signal intensity equal to or greater than a predetermined value, the light receiving element outputs a detection voltage as an output value indicating the amount of received light, according to the amount of received light.

In the label detector 56, the light emitting unit 58 and the light receiving unit 59 can be disposed at positions where the light receiving unit 59 can receive the light emitted from the light emitting unit 58 with a predetermined signal intensity. In this case, the output value indicating the amount of light received by the light receiving unit 59 differs between when the label sheet 100 is not present directly below the light receiving unit 59, when the backing sheet 101 is present, and when the label 103 is present. That is, the signal intensities of the light emitted from the light emitting unit 58, the light transmitted through the backing sheet 101, and the light transmitted through the label 103 are different from each other. Therefore, the label detector 56 can detect the leading end and the trailing end of the label sheet 100 and the leading end and the trailing end of the label 103, based on the output value indicating the amount of light received by the light receiving unit 59.

A drive member 12 is provided inside the device case 10. Each part provided in the conveying unit 24 is attached to the drive member 12. In the present embodiment, the drive member 12 is formed in the shape of a housing, and each part provided in the conveying unit 24 and the label detector 56 are housed therein.

A cutter unit 110 is disposed downstream of the print head 42, that is, to the front of the print head 42. The cutter unit 110 includes a fixed blade 112 and a movable blade 114 disposed with the conveyance path R interposed therebetween, and the movable blade 114 is coupled to a drive device such as a motor that drives the cutter, via a gear or the like. In the cutter unit 110, when the motor is driven, the movable blade 114 moves toward the fixed blade 112 and cuts the label sheet 100. The cutter unit 110 may be configured to partially cut the label sheet 100, leaving an uncut part in the width direction of the label sheet 100, or may be configured to cut the label sheet 100 completely. The printing device 1 cuts the label sheet 100 printed by the print head 42 to a predetermined length with the cutter unit 110 and discharges the cut part from the paper discharge port 14.

The cutter unit 110 may be formed separately from the printing device 1 and may be detachably provided, for example, at the front surface of the printing device 1.

The printing device 1 includes a control board 18 that controls each unit of the printing device 1.

The control board 18 is an example of a “control unit”.

At the front surface of the printing device 1, a take-up unit 120 is detachably formed below the paper discharge port 14. The take-up unit 120 includes a take-up drum 122 that winds up the label sheet 100 discharged from the paper discharge port 14, and a take-up motor 124, which is a drive device that rotates the take-up drum 122.

The take-up drum 122 is a columnar or cylindrical shaft member having a longitudinal direction extending along the intersecting direction I.

The take-up drum 122 is driven by the take-up motor 124 provided in the take-up unit 120. The take-up drum 122 rotates toward the front side of the printing device 1 and winds up the label sheet 100 discharged from the paper discharge port 14. When the take-up unit 120 is used, the printing device 1 does not cut the label sheet 100 with the cutter unit 110 and discharges the label sheet 100 in a long continuous state from the paper discharge port 14. The take-up unit 120 can allow the printing device 1 to print on the entirety of one roll of the label sheet 100 accommodated in the accommodation unit 20, for example, by one operation of the printing device 1, and can wind up the label sheet 100 around the take-up drum 122.

The take-up drum 122 may be driven by a rotational force transmitted from the conveyance motor 52 via a gear train or the like.

Next, the paper guide unit 30 will be described in detail.

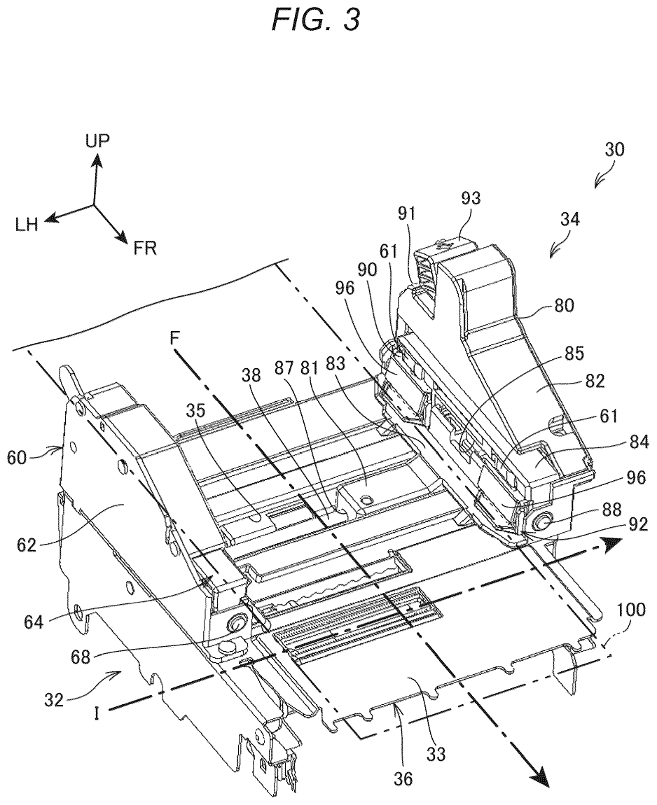

FIG. 2 is a perspective view of the paper guide unit 30 as viewed from the left. FIG. 3 is a perspective view of the paper guide unit 30 as viewed from the right. In FIGS. 2 and 3, the direction of conveyance F and the intersecting direction I are indicated by one-dot chain lines, and the label sheet 100 is indicated by two-dot chain lines.

As shown in FIGS. 2 and 3, the lower guide member 32 includes a support plate 36 having a substantially flat upper surface 33. The support plate 36 has a predetermined length dimension in the front-rear direction, and has a width dimension greater than the width dimension of the label sheet 100 along the left-right direction. The support plate 36 is a member that covers the label sheet 100 guided by the paper guide unit 30, from below.

A slide opening 35 penetrating the support plate 36 in the up-down direction is provided substantially at the center of the support plate 36. The slide opening 35 is an elongated hole extending along the intersecting direction I.

The lower guide member 32 includes a guide shaft 38. The guide shaft 38 is a shaft member disposed on the lower surface side of the support plate 36 and having a longitudinal direction extending along the intersecting direction I.

At the upper surface 33 of the support plate 36, the paper hold-down member 34 is provided at the two end parts located along the intersecting direction I. The paper hold-down member 34 is a member that is located above the label sheet 100 so as to face the lower guide member 32, and that holds down the label sheet 100 so as to prevent the label sheet 100 from floating. The paper hold-down member 34 includes a fixed hold-down member 60 and a movable hold-down member 80.

The fixed hold-down member 60 is provided at a right end part of the support plate 36, and the movable hold-down member 80 is provided at a left end part. The fixed hold-down member 60 and the movable hold-down member 80 are disposed to face each other along the intersecting direction I on the upper surface 33. The label sheet 100 guided by the paper guide unit 30 is conveyed between the fixed hold-down member 60 and the movable hold-down member 80.

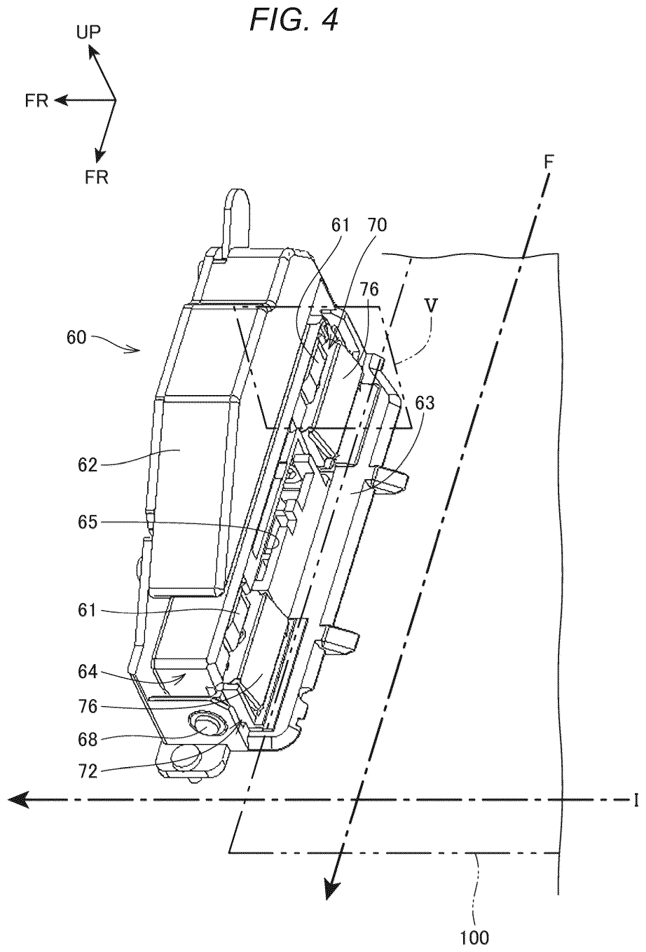

FIG. 4 is a perspective view of the fixed hold-down member 60 as viewed from the left. In FIG. 4, the direction of conveyance F and the intersecting direction I are indicated by one-dot chain lines, and the label sheet 100 is indicated by two-dot chain lines.

The fixed hold-down member 60 is fixed to the upper surface 33 of the support plate 36. The fixed hold-down member 60 includes a hold-down member main body 62. The hold-down member main body 62 is in the shape of a box having a longitudinal direction extending along the front-rear direction and whose surface facing the movable hold-down member 80 is opened.

At the lower end of the hold-down member main body 62, an extending part 63 extending with a predetermined length dimension is provided on the movable hold-down member 80 side along the support plate 36. The extending part 63 is provided over the entire longitudinal direction of the hold-down member main body 62.

A pressing part 64 is housed inside the hold-down member main body 62. The pressing part 64 is in the shape of a box having a longitudinal direction extending along the front-rear direction and whose lower surface and surface facing the movable hold-down member 80 are opened. The pressing part 64 is provided with a pressing part opening 65 on a surface facing the movable hold-down member 80. Thus, the surface of the pressing part 64 facing the movable hold-down member 80 is opened.

The two ends of the pressing part 64 are supported to the hold-down member main body 62 by a rotational movement shaft 68 so as to be rotationally movable. The pressing part 64 is supported in a rotationally movable manner such that the pressing part opening 65 moves from a position facing the movable hold-down member 80 to a position facing the support plate 36.

In the pressing part 64, a plurality of pressing elements 61 are provided at the upper edge of the pressing part opening 65. The pressing element 61 protrudes with a predetermined length dimension from the upper edge toward the movable hold-down member 80. In the present embodiment, the pressing element 61 is provided at each of a front end part and a rear end part of the upper edge of the pressing part opening 65.

When the pressing part 64 rotationally moves such that the pressing part opening 65 moves to a position facing the upper surface 33, the pressing element 61 moves to a position facing the extending part 63.

Each of a first guide 70 and a third guide 72 includes an abutting element 76 having a predetermined length dimension and protruding toward the movable hold-down member 80.

The abutting element 76 provided in the first guide 70 is disposed at a rear end part of the fixed hold-down member 60, and the abutting element 76 provided in the third guide 72 is disposed at a front end part of the fixed hold-down member 60.

When the pressing part 64 is disposed such that the pressing part opening 65 faces the movable hold-down member 80, the abutting element 76 provided in each of the first guide 70 and the third guide 72 is exposed to outside via the pressing part opening 65.

When the pressing part 64 moves to a position where the pressing element 61 faces the extending part 63, the first guide 70, the third guide 72, and the abutting element 76 provided in each of the first guide 70 and the third guide 72 are covered on the upper side and the side facing the movable hold-down member 80 by the pressing part 64.

Next, the movable hold-down member 80 will be described.

As shown in FIGS. 2 and 3, the movable hold-down member 80 is provided at the upper surface 33 of the support plate 36. The movable hold-down member 80 includes a hold-down member main body 82. The hold-down member main body 82 is in the shape of a box having a longitudinal direction extending along the front-rear direction and whose surface facing the fixed hold-down member 60 is opened.

At the lower end of the hold-down member main body 82, an extending part 83 extending with a predetermined length dimension is provided on the fixed hold-down member 60 side along the support plate 36. The extending part 83 is provided over the entire longitudinal direction of the hold-down member main body 82.

A shaft insertion part 81 is provided at the bottom surface of the hold-down member main body 82. The shaft insertion part 81 is formed in a substantially rectangular parallelepiped shape having a longitudinal direction extending along the intersecting direction I. A shaft hole 87 is provided at the two ends of the shaft insertion part 81 in the longitudinal direction.

The guide shaft 38 is inserted into each of the shaft holes 87. Thus, the movable hold-down member 80 is supported to be slidable along the intersecting direction I. In the movable hold-down member 80, the hold-down member main body 82 is disposed on the upper surface side of the support plate 36, and the shaft insertion part 81 is disposed on the lower surface side of the support plate 36.

The movable hold-down member 80 includes a lock mechanism 91 that locks and unlocks the movable hold-down member 80 in relation to the guide shaft 38. A lock release lever 93 is provided at the top surface of the hold-down member main body 82. The user can operate the lock release lever 93 to lock or unlock the movable hold-down member 80 in relation to the guide shaft 38.

A pressing part 84 is housed inside the hold-down member main body 82. The pressing part 84 is formed in substantially the same shape as the pressing part 64. The pressing part 84 is in the shape of a box having a longitudinal direction extending along the front-rear direction and whose lower surface and surface facing the fixed hold-down member 60 are opened. The pressing part 84 is provided with a pressing part opening 85 on a surface facing the fixed hold-down member 60. Thus, the surface of the pressing part 84 facing the fixed hold-down member 60 is opened.

The two ends of the pressing part 84 are supported to the hold-down member main body 82 by a rotational movement shaft 88 so as to be rotationally movable.

Similarly to the pressing part 64, the pressing part 84 is supported in a rotationally movable manner such that the pressing part opening 85 moves from a position facing the fixed hold-down member 60 to a position facing the support plate 36.

In the pressing part 84, a plurality of pressing elements 61 are provided at the upper edge of the pressing part opening 85. The pressing element 61 protrudes with a predetermined length dimension from the upper edge toward the fixed hold-down member 60. In the present embodiment, the pressing element 61 is provided at each of a front end part and a rear end part of the upper edge of the pressing part opening 85. The pressing element 61 provided in the pressing part 84 has substantially the same shape as the pressing element 61 provided in the pressing part 64.

When the pressing part 84 rotationally moves such that the pressing part opening 85 moves to a position facing the upper surface 33, the pressing element 61 moves to a position facing the extending part 83.

Similarly to the pressing part 64, the pressing part 84 is coupled to the hold-down member main body 82 by an extension spring at substantially the center in the longitudinal direction. The pressing part 84 is energized by the extension spring so as to be pulled in a direction away from the fixed hold-down member 60. When the pressing element 61 moves to a position facing the extending part 83, the pressing part 84 is fixed to maintain the position.

The hold-down member main body 82 is provided with a second guide 90 and a fourth guide 92. Both the second guide 90 and the fourth guide 92 are housed inside the pressing part 84. The second guide 90 is disposed on the rear end side of the movable hold-down member 80, and the fourth guide 92 is disposed on the front end side of the movable hold-down member 80.

The second guide 90 is disposed at a position facing the first guide 70 across the label sheet 100, and the fourth guide 92 is disposed at a position facing the third guide 72 across the label sheet 100. That is, in the paper guide unit 30, the second guide 90 is disposed on the side opposite to the first guide 70 across the label sheet 100, and the fourth guide 92 is disposed on the side opposite to the third guide 72 across the label sheet 100.

The second guide 90 and the fourth guide 92 are provided to be slidable along the intersecting direction I in relation to the hold-down member main body 82. When the pressing part 84 rotationally moves such that the pressing part opening 85 moves to a position facing the upper surface 33, the second guide 90 and the fourth guide 92 are pressed by the pressing part 84 and slide in a direction away from the fixed hold-down member 60. When the pressing part 84 rotationally moves again such that the pressing part opening 85 is disposed at a position facing the fixed hold-down member 60, the second guide 90 and the fourth guide 92 are pressed by the pressing part 84 and slide in a direction toward the fixed hold-down member 60.

In this case, the fourth guide 92 is disposed at a position farther away from the center of the support plate 36 in the intersecting direction I than the second guide 90.

Each of the second guide 90 and the fourth guide 92 includes an abutting element 96 having a predetermined length dimension and protruding toward the fixed hold-down member 60. The abutting element 96 is formed in substantially the same shape as the abutting element 76.

The abutting element 96 provided in the second guide 90 is disposed at a rear end part of the movable hold-down member 80, and the abutting element 96 provided in the fourth guide 92 is disposed at a front end part of the movable hold-down member 80.

When the pressing part 84 is disposed such that the pressing part opening 85 faces the fixed hold-down member 60, the abutting element 96 provided in each of the second guide 90 and the fourth guide 92 is exposed to outside via the pressing part opening 85.

When the pressing part 84 moves to a position where the pressing element 61 faces the extending part 83, the second guide 90, the fourth guide 92, and the abutting element 96 provided in each of the second guide 90 and the fourth guide 92 are covered on the upper side and the side facing the fixed hold-down member 60 by the pressing part 84.

Each of the first guide 70, the second guide 90, the third guide 72, and the fourth guide 92 is an example of a “guide part”.

When the label sheet 100 is placed in the paper guide unit 30, the user first places the label sheet 100 above the support plate 36 in the state where the movable hold-down member 80 is disposed at the right end of an available movement range. Next, the user operates the lock release lever 93 to unlock the movable hold-down member 80 in relation to the guide shaft 38. In this state, the user slides the movable hold-down member 80 in the paper width direction of the label sheet 100, that is, in the intersecting direction I, and thus adjusts the distance between the fixed hold-down member 60 and the movable hold-down member 80.

The user operates the lock release lever 93 to lock the movable hold-down member 80 in relation to the guide shaft 38 in the state where the abutting element 76 of the first guide 70 is abutting on the left end of the label sheet 100 and the abutting element 96 of the second guide 90 is abutting on the right end of the label sheet 100. Thus, the movable hold-down member 80 is fixed in the state of abutting on the right end of the label sheet 100.

Next, the user rotationally moves the pressing part 64 and the pressing part 84 to a position where each of the pressing elements 61 faces the extending part 63 or the extending part 83. Thus, the label sheet 100 is sandwiched between each of the pressing elements 61 and the extending part 63 or the extending part 83 in the up-down direction.

Therefore, in the printing device 1, the label sheet 100 is prevented from floating up and being spaced apart from the upper surface 33 of the support plate 36, and the occurrence of jamming of the label sheet 100, a deviation of the printing position, and the like, is suppressed.

When the pressing part 64 and the pressing part 84 are rotationally moved to a position where each of the pressing elements 61 faces the extending part 63 or the extending part 83, the second guide 90, the third guide 72, and the fourth guide 92 move in a direction away from the label sheet 100.

Since the third guide 72 and the fourth guide 92 move away from the label sheet 100, in the printing device 1, the end parts of the backing sheet 101 in the intersecting direction I are prevented from coming into contact with the third guide 72 and the fourth guide 92. In the label sheet 100, the end parts of the backing sheet 101 in the intersecting direction I are stripping parts to which the label 103 is not attached.

Thus, in the printing device 1, the bending of the end parts of the stripping parts located on the left and right sides of the label sheet 100 due to the stripping parts coming into contact with the third guide 72 and the fourth guide 92 as the label sheet 100 is conveyed, is suppressed.

Moreover, since the second guide 90 moves away from the label sheet 100, in the printing device 1, when the width dimension along the intersecting direction I of the label sheet 100 is not uniform along the direction of conveyance F, the second guide 90 is prevented from coming into contact with the label sheet 100.

Thus, in the printing device 1, when the width dimension of the label sheet 100 along the intersecting direction I is not uniform in the direction of conveyance F, the bending of the left and right end parts of the label sheet 100 due to the second guide 90 coming into contact with the label sheet 100 is suppressed.

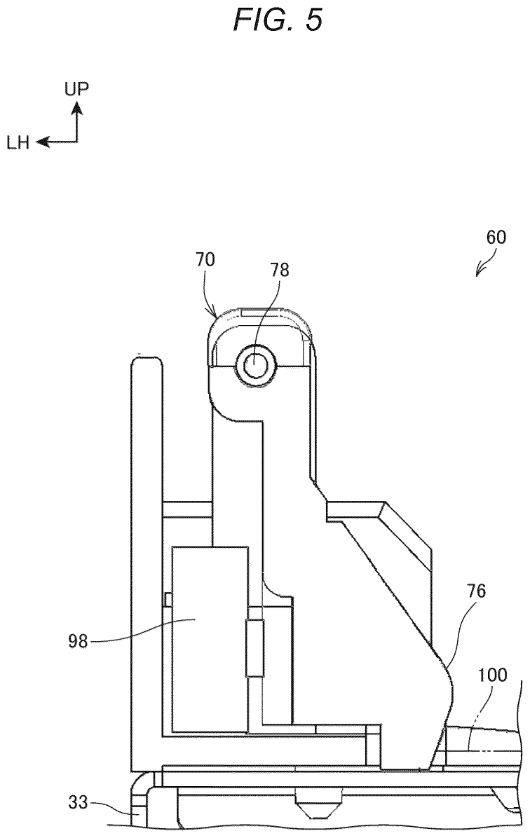

FIG. 5 shows a cross section along a plane V in FIG. 4 as viewed from the front. The plane V is a plane orthogonal to the front-rear direction and intersecting the abutting element 76 of the first guide 70. In FIG. 5, the pressing part 64 is omitted for the convenience of description.

As shown in FIG. 5, in the first guide 70, the abutting element 76 is supported to the first guide 70 in a rotationally movable manner via a rotational movement shaft 78. The longitudinal direction of the rotational movement shaft 78 extends in the front-rear direction, and the abutting element 76 rotationally moves along the intersecting direction I about the rotational movement shaft 78.

The first guide 70 includes a strain gauge 98. The strain gauge 98 is a sensor that is pressed and deformed and thus measures a pressing force on the strain gauge 98. The strain gauge 98 is disposed, abutting on the abutting element 76 from the side opposite to the support plate 36 across the abutting element 76 in the intersecting direction I.

Thus, for example, in the conveyance of the label sheet 100, when the label sheet 100 abuts on the abutting element 76, the abutting element 76 rotationally moves and presses the strain gauge 98. Therefore, the strain gauge 98 can measure the load applied to the abutting element 76 by the label sheet 100.

In the third guide 72, as in the first guide 70, the abutting element 76 is supported to the third guide 72 in a rotationally movable manner via a rotational movement shaft 78. In the second guide 90, the abutting element 96 is supported to the second guide 90 in a rotationally movable manner via a rotational movement shaft 78. In the fourth guide 92, the abutting element 96 is supported to the fourth guide 92 in a rotationally movable manner via a rotational movement shaft 78.

Similarly to the first guide 70, each of the third guide 72, the second guide 90, and the fourth guide 92 includes a strain gauge 98 disposed, abutting on the abutting element 76 or the abutting element 96 from the side opposite to the support plate 36 across the abutting element 76 or the abutting element 96 in the intersecting direction I.

The strain gauge 98 provided in each of the first guide 70, the second guide 90, the third guide 72, and the fourth guide 92 is an example of an “amount-of-skew measurement unit”.

### Next, a Rotation Drive Unit 150 Will Be described.

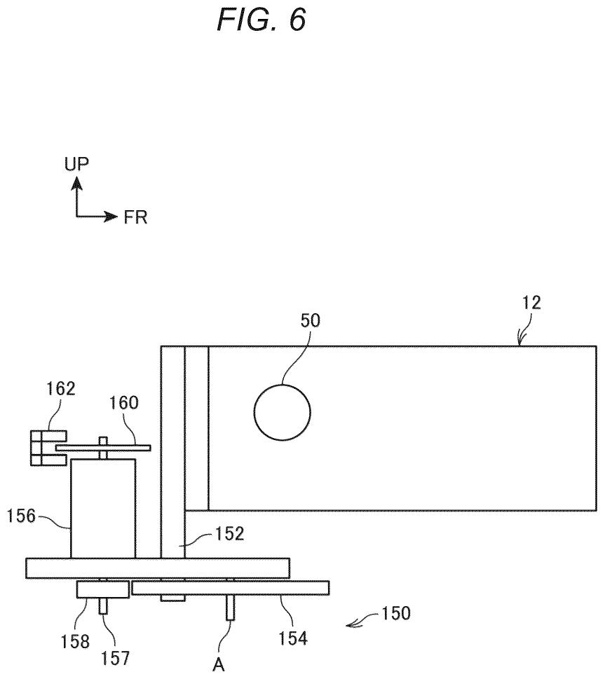

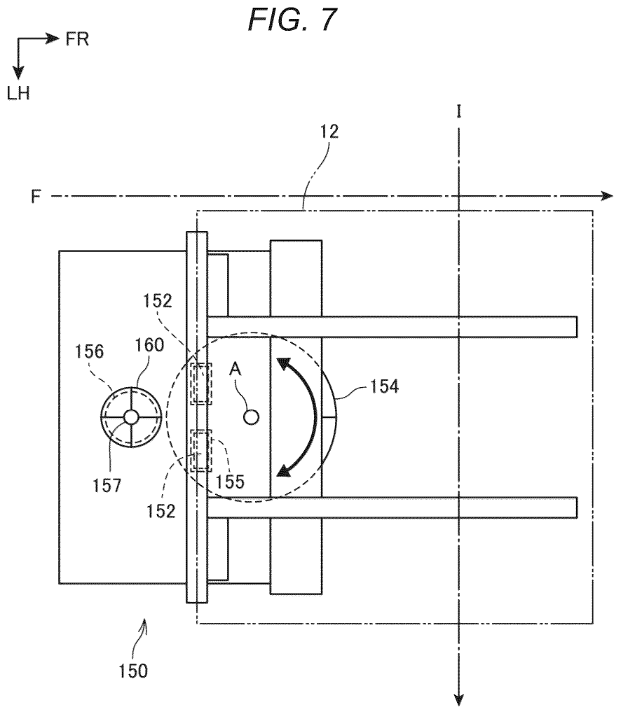

FIG. 6 shows the drive member 12 and the rotation drive unit 150 as viewed from the left. FIG. 7 is a plan view of the drive member 12 and the rotation drive unit 150.

As illustrated in FIGS. 6 and 7, the printing device 1 is provided with the rotation drive unit 150. The rotation drive unit 150 rotationally drives the drive member 12.

The rotation drive unit 150 includes a support shaft 152, a gear 154, and a motor 156.

The support shaft 152 is an elongated member extending in the up-down direction. In the present embodiment, two support shafts 152 are arranged side by side along the intersecting direction I in the printing device 1. As shown in FIG. 6, an upper end part of each support shaft 152 is coupled to the rear end of the drive member 12.

A lower end part of the support shaft 152 is coupled to the gear 154. The gear 154 is disposed such that a rotating shaft A extends along the up-down direction. As illustrated in FIG. 7, the gear 154 is provided with a pair of insertion holes 155 penetrating the gear 154 in the plate thickness direction. In the gear 154, the insertion hole 155 is located more to the rear than the rotating shaft A, extends along the intersecting direction I as viewed in a plan view, and is provided at positions that are line-symmetrical about a symmetry line intersecting the rotating shaft A. The lower end part of the support shaft 152 is inserted into each of the insertion holes 155.

As illustrated in FIGS. 6 and 7, the motor 156 includes a gear 158 attached to a rotating shaft 157 provided in the motor 156, and the gear 158 and the gear 154 are disposed to mesh with each other.

The rotating shaft 157 is provided with a disk-shaped encoder scale 160.

The rotation drive unit 150 includes an amount-of-rotation measurement device 162. The amount-of-rotation measurement device 162 is, for example, an optical transmissive sensor. The amount-of-rotation measurement device 162 reads the encoder scale 160 rotating with the rotation of the motor 156.

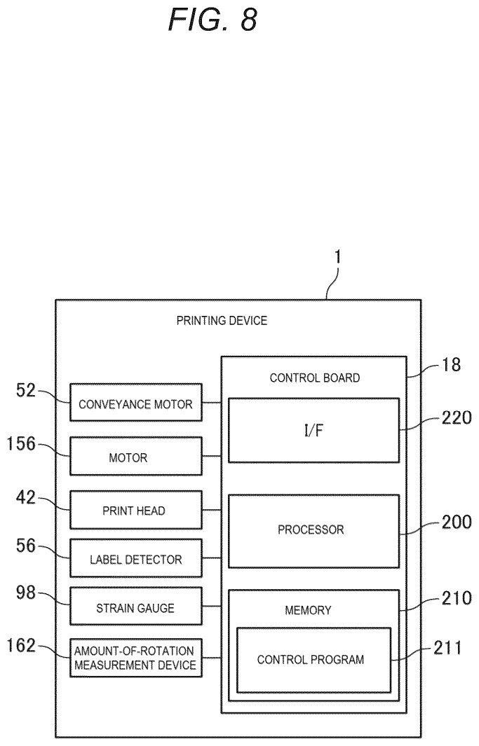

FIG. 8 is a block diagram showing the configuration of the control system of the printing device 1.

As illustrated in FIG. 8, the control board 18 includes a processor 200 such as a central processing unit (CPU) or a micro processor unit (MPU). The processor 200 functions as an arithmetic execution unit.

The control board 18 includes a memory 210.

The memory 210 is a storage device that stores programs and data. The memory 210 stores a control program 211 and data processed by the processor 200. The memory 210 has a nonvolatile storage area. The memory 210 also has a volatile storage area, which forms a work area of the processor 200. The memory 210 includes, for example, a read-only memory (ROM) or a random-access memory (RAM).

The control board 18 controls each part of the printing device 1 and performs various operations as the processor 200 reads and executes the control program 211 stored in the memory 210.

The control board 18 includes an interface circuit 220 for coupling other devices and sensors. Various components of the printing device 1 such as the print head 42, the conveyance motor 52, the motor 156, and various sensors are coupled to the interface circuit 220.

The control board 18 detects operations by the user, the amount of conveyance of the label sheet 100, and the like.

The control board 18 controls the drive devices provided in the printing device 1, such as the conveyance motor 52 and the motor 156.

The control board 18 causes the print head 42 to perform printing on the print medium.

The control board 18 causes the light emitting element to emit light and acquires a detection value of the label detector 56.

The control board 18 is formed to be able to acquire a measurement value of the strain gauge 98 provided in each of the first guide 70, the second guide 90, the third guide 72, and the fourth guide 92. That is, each of the strain gauges 98 functions as a detection unit in cooperation with the control board 18.

The control board 18 is formed to be able to acquire a measurement value of the amount-of-rotation measurement device 162. That is, the amount-of-rotation measurement device 162 functions as a detection unit in cooperation with the control board 18.

Next, the operation in the present embodiment will be described.

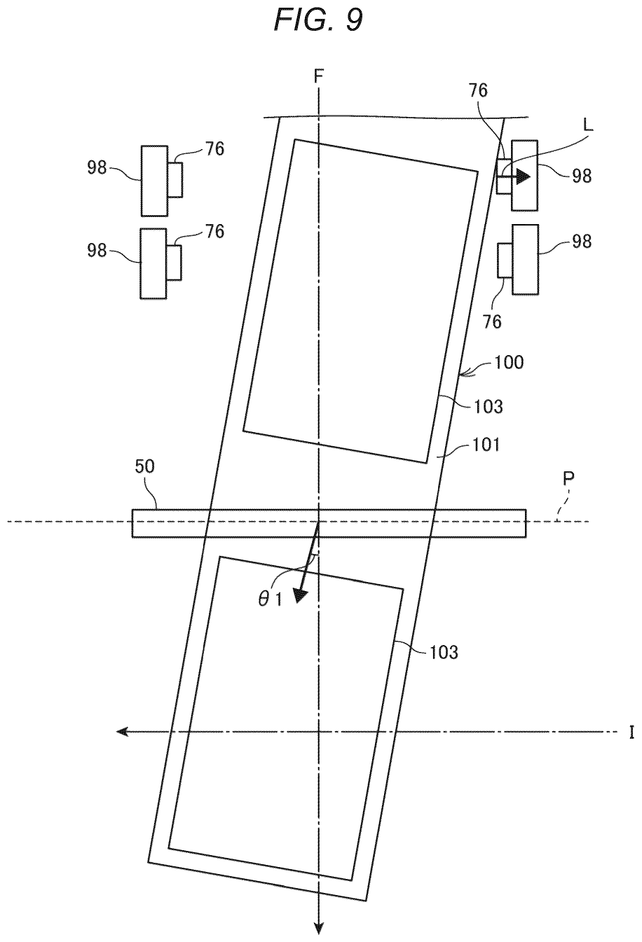

FIG. 9 is a plan view illustrating the label sheet 100 conveyed by the conveying roller 50.

In the printing device 1, a skew in which the label sheet 100 shifts in a direction intersecting the direction of conveyance F may occur in the conveyance path R, depending on the assembly accuracy of the printing device 1, the accuracy of members such as the take-up drum 122 attached to the printing device 1, or the like.

In this case, the conveyed label sheet 100 abuts on one of the first guide 70, the second guide 90, the third guide 72, and the fourth guide 92, and presses, with a predetermined force L, the one guide on which the label sheet 100 abuts. When one of the first guide 70, the second guide 90, the third guide 72, and the fourth guide 92 is pressed by the label sheet 100, the strain gauge 98 detects and measures the force L as a load.

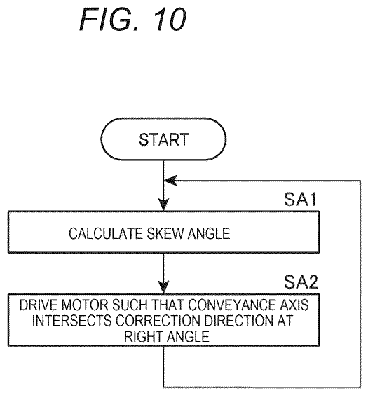

FIG. 10 is a flowchart showing an operation of the printing device 1. FIG. 10 illustrates an operation performed when the printing device 1 performs printing.

As illustrated in FIG. 10, the control board 18 acquires the load measured by the strain gauge 98 and calculates a skew angle θ1 from the load (step SA1).

As illustrated in FIG. 9, the skew angle θ1 is an angle formed by the direction of conveyance F and the direction in which the label sheet 100 is conveyed due to the skew. The disclosers have found that the amount of skew, that is, the skew angle θ1, increases as the load measured by the strain gauge 98 increases.

The control board 18 calculates the skew angle θ1 by an algorithm in which the calculated skew angle θ1 increases as the load measured by the strain gauge 98 increases.

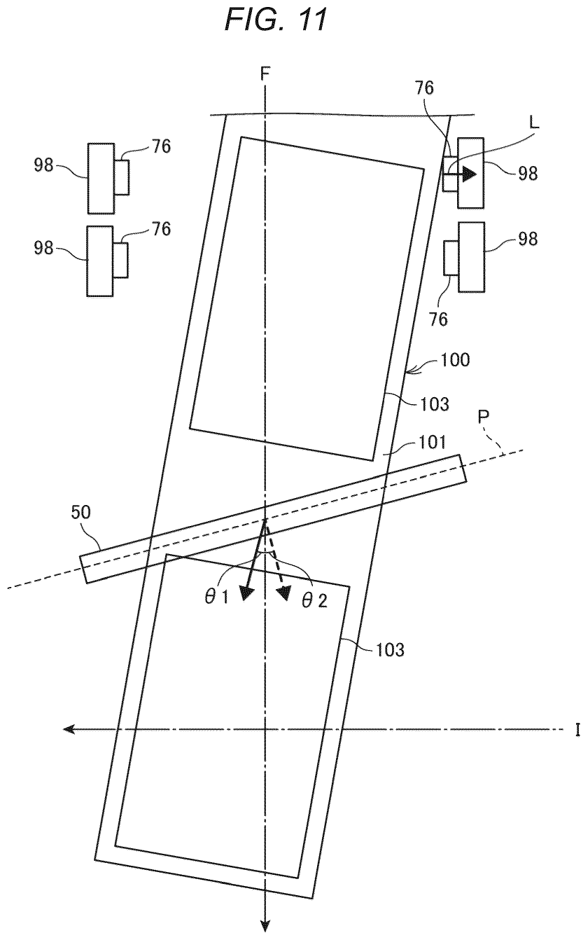

FIG. 11 is a plan view illustrating the label sheet 100 conveyed by the conveying roller 50.

Next, the control board 18 drives the motor 156 such that the conveyance axis P of the conveying roller 50 becomes perpendicular to a correction direction (step SA2).

The correction direction is a direction that is line-symmetric about the symmetry axis extending along the direction of conveyance F on the plane of the label sheet 100, in contrast to the direction in which the label sheet 100 is conveyed due to the generation of the skew. As illustrated in FIG. 11, the correction direction and the direction of conveyance F form a correction angle θ2 that is substantially the same angle as the skew angle θ1.

The conveyance axis P is an axis extending along the longitudinal direction of the conveying roller 50.

Thus, in the printing device 1, the label sheet 100 is conveyed so as to be in the correction direction, and the amount of skew occurring in the label sheet 100 can be reduced. Therefore, in the printing device 1, the end parts of the label sheet 100 in the width direction are prevented from abutting on the paper guide unit 30 and thus being bent.

When the load measured by the strain gauge 98 is 0 in step SA1, the control board 18 may not drive the motor 156. In this case, the control board 18 performs step SA1 again.

The above-described embodiment is simply an example of one aspect of the present disclosure and can be freely modified and applied within the scope and spirit of the present disclosure.

In the above-described embodiment, the printing device 1 includes the strain gauge 98 as the amount-of-skew measurement unit. However, the amount-of-skew measurement unit is not limited thereto, and the printing device 1 may use various sensors that can measure a load such as a piezoelectric sensor, or the like.

The printing device 1 may include a paper edge sensor as the amount-of-skew measurement unit. For example, in the paper guide unit 30, the paper edge sensor may be a transmissive optical sensor including a light emitting unit on the paper hold-down member 34 side and a light receiving unit on the lower guide member 32 side, as in the label detector 56. The output value indicating the amount of light received by the paper edge sensor differs, depending on the presence or absence of the label sheet 100 at the position of the paper edge sensor. Thus, the printing device 1 can detect the end part of the label sheet 100 in the width direction, using the paper edge sensor. The control board 18 may calculate the amount of skew of the label sheet 100 by detecting the positional deviation of the end part of the label sheet 100 by the paper edge sensor and measuring the amount of the positional deviation. For example, the paper edge sensor may be an image pickup device such as a line scan camera or the like.

In the above-described embodiment, the take-up unit 120 is provided at the front surface of the printing device 1. However, the present disclosure is not limited thereto, and another device such as a peeler that performs processing of separating the label 103 from the backing sheet 101 may be provided at the front surface of the printing device 1.

In the above-described embodiment, a label printer is described as an example of the printing device 1. However, the printing device 1 is not limited to a label printer. The printing device 1 may be any device including a conveying device that conveys a print medium and a printing unit that performs printing on the print medium. For example, the printing device 1 may be a large format printer, a multifunction peripheral, or the like.

In the above-described embodiment, a line head type is described as an example of the print head 42, but the print head 42 is not limited thereto and a serial head type may be used. The printing method of the print head 42 is not limited to the inkjet method.

The processor 200 may be configured with a single processor or may be configured with a plurality of processors. These processors may be hardware programmed to implement the corresponding functional units. That is, these processors may be configured with, for example, an application-specific integrated circuit (ASIC), a field-programmable gate array (FPGA) or the like.

The configuration of each part of the printing device 1 in FIG. 8 is an example, and the specific implementation form thereof is not particularly limited. That is, pieces of hardware individually corresponding to the units need not necessarily be installed, and one processor can be configured to execute a program to implement the functions of the units. Also, some of the functions implemented by software in the above-described embodiment may be implemented by hardware, or some of the functions implemented by hardware may be implemented by software.

The steps of the operation illustrated in FIG. 10 are provided by dividing the operation according to the main processing content in order to facilitate the understanding of the operation, and is not limited by the way the operation is divided into processing elements and the names thereof. The operation may be divided into more steps according to the processing content. The operation may also be divided such that one step unit includes more processing. The order of the steps may be changed appropriately without causing any problem to the gist of the present disclosure.

The directions such as the horizontal and vertical directions and the various numerical values and shapes in the above-described embodiment include an equivalent range that achieves the same functions and effects as those of the directions, numerical values, and shapes unless otherwise specified.

### Summary of Present Disclosure

The present disclosure will be summarized below as appendices.

Appendix 1

A printing device includes: a conveying roller that extends in a direction intersecting a direction of conveyance along a surface of a print medium and conveys the print medium; a print head that is located downstream of the conveying roller in a conveyance path of the print medium; an amount-of-skew measurement unit that measures an amount of skew occurring in the print medium; a support shaft that extends in a direction intersecting the surface of the print medium and is coupled to the conveying roller; a rotation drive unit that rotates the conveying roller via the support shaft; and a control unit, wherein the control unit performs feedback control for driving the rotation drive unit according to a measurement result from the amount-of-skew measurement unit.

Thus, in the printing device, when a skew occurs in the print medium, the direction of conveyance can be corrected and the amount of skew occurring in the print medium can be reduced. Therefore, in the printing device, the end part of the print medium in the width direction is prevented from abutting on the member on the conveyance path and thus being bent.

Appendix 2

In the printing device according to Appendix 1, the amount-of-skew measurement unit measures the amount of skew by measuring a load received from the print medium when the print medium comes into contact with the amount-of-skew measurement unit.

Thus, in the printing device, the amount of skew occurring in the print medium can be measured with higher accuracy.

Appendix 3

In the printing device according to Appendix 1, the amount-of-skew measurement unit measures the amount of skew by detecting a position of an end part of the print medium.

Thus, in the printing device, the amount of skew can be measured with higher accuracy.

Appendix 4

The printing device according to any one of Appendices 1 to 3, further includes a guide part that guides the print medium from a width direction of the print medium, and the amount-of-skew measurement unit is provided in the guide part.

As a result, in the printing device, the amount of skew occurring in the print medium can be measured without increasing the number of members that abut on the end part of the print medium.

Appendix 5

In the printing device according to Appendix 4, as the guide part, at least two guide parts are provided with the print medium interposed therebetween in a width direction of the print medium.

Thus, in the printing device, the amount of skew occurring in the print medium can be measured regardless of the direction in which the print medium is skewed.

Appendix 6

In the printing device according to any one of Appendices 1 to 5, the control unit finds a skew angle of the print medium, based on the measurement result from the amount-of-skew measurement unit, and drives the rotation drive unit until an angle orthogonal to a longitudinal direction of the roller main body reaches an angle that is in line symmetry with the skew angle about a symmetry axis extending along a direction of conveyance of the print medium, on a plane of the print medium.

Thus, in the printing device, even when a skew occurs in the print medium, the direction of conveyance can be corrected and the amount of skew occurring in the print medium can be reduced.

What is claimed is:

1. A printing device comprising:
a conveying roller that extends in a direction intersecting a direction of conveyance along a surface of a print medium and conveys the print medium;
a print head that is located downstream of the conveying roller in a conveyance path of the print medium;
an amount-of-skew measurement unit that measures an amount of skew occurring in the print medium;
a support shaft that extends in a direction intersecting the surface of the print medium and is coupled to the conveying roller;
a rotation drive unit that rotates the conveying roller via the support shaft; and
a control unit, wherein
the control unit performs feedback control for driving the rotation drive unit according to a measurement result from the amount-of-skew measurement unit.

2. The printing device according to claim 1, wherein
the amount-of-skew measurement unit measures the amount of skew by measuring a load received from the print medium when the print medium comes into contact with the amount-of-skew measurement unit.

3. The printing device according to claim 1, wherein
the amount-of-skew measurement unit measures the amount of skew by detecting a position of an end part of the print medium.

4. The printing device according to claim 1, further comprising:
a guide part that guides the print medium from a width direction of the print medium, wherein
the amount-of-skew measurement unit is provided in the guide part.

5. The printing device according to claim 4, wherein
the guide part comprises at least two guide parts to interpose the print medium interposed therebetween in a width direction of the print medium.

6. The printing device according to claim 1, wherein
the control unit finds a skew angle of the print medium, based on the measurement result from the amount-of-skew measurement unit, and drives the rotation drive unit until an angle orthogonal to a longitudinal direction of the conveying roller reaches an angle that is in line symmetry with the skew angle about a symmetry axis extending along a direction of conveyance of the print medium, on a plane of the print medium.
